(19) United States
(12) Patent Application Publication
(10) Pub. No.: US 2010/0161897 A1
(43) Pub. Date: Jun. 24, 2010

(54) METADATA SERVER AND DISK VOLUME SELECTING METHOD THEREOF

(75) Inventors: Sang Min LEE, Daejeon (KR); Young Kyun KIM, Daejeon (KR); Han NAMGOONG, Daejeon (KR)

Correspondence Address: AMPACC Law Group, 3500 188th Street S.W., Suite 103, Lynnwood, WA, 98037, US

(73) Assignee: Electronics and Telecommunications Research Institute, Daejeon (KR)

(21) Appl. No.: 12/511,855

(22) Filed: Jul. 29, 2009

(30) Foreign Application Priority Data
Dec. 22, 2008 (KR) 10-2008-0131745

(51) Int. Cl. G06F 12/02; G06F 12/00

(52) U.S. Cl. 711/112; 711/170; 707/E17.01; 707/E17.044; 711/E12.001; 711/E12.002

(57) ABSTRACT

A metadata server in an asymmetric cluster file system detects the used capacity and the free capacity of a disk volume in a data server to allocate chucks. The method for selecting a disk volume includes receiving status information from a data server periodically and adjusting the standby command number of a disk volume in the disk server on the basis of the status information, and selecting a disk volume for chunk allocation on the basis of the standby command number in response to a chunk allocation request from a client.

### CROSS-REFERENCE TO RELATED APPLICATIONS

This application claims priority under 35 U.S.C. §119 to Korean Patent Application No. 10-2008-0131745, filed on Dec. 22, 2008, in the Korean Intellectual Property Office, the disclosure of which is incorporated herein by reference in its entirety.

### TECHNICAL FIELD

The following disclosure relates to a method for selecting a data storage space in an asymmetric cluster file system, and in particular, to a method for selecting a disk volume by a metadata server in an asymmetric cluster file system.

### BACKGROUND

An asymmetric cluster file system includes a metadata server (MDS), data servers (DSs), and client systems, which are connected on a local network to interoperate through communication. Herein, the metadata server manages metadata of files, the data servers manage data of the files, and client systems store or search the files.

A plurality of data servers may be treated as a large-scale single storage space by virtualization technology, and management of the storage space can be easily performed by addition/deletion of a data server or a disk volume in a data server.

In consideration of a failure rate, which is proportional to the number of servers, a system managing a plurality of data servers supports a replication function for data. For example, a data replica is provided, or data are distributed across the several disks and parity is provided for an error correction code, as in Redundant Array of Inexpensive Disks (RAID) level 5.

In either case, data are not stored in one server but are stored in several data servers in a distributed manner to increase the reliability and improve the performance by load distribution.

However, in the structure of storing data in a distributed manner, if a new data server or disk volume is added for storage space expansion or if a failed data server or disk volume is replaced with a new data server or disk volume for system recovery, a storage space utilization difference occurs between the in-use disk volume and the new disk volume.

In this case, if a data storage disk volume is selected in a round-robin manner, an unbalanced situation continues without improvement. Accordingly, an I/O load may not be well distributed, and the I/O load may still be concentrated on the old disk volume having more files than the new disk volume. Thus, the total system performance may degrade with an increase in the number of clients.

The Korean Patent Publication No. 2006-0042989 titled “PROGRAM, METHOD AND APPARATUS FOR VIRTUAL STORAGE MANAGEMENT” discloses a method for allocating a physical disk to construct a virtual volume of a capacity designated by a user, among physical disk volumes constituting a storage pool.

The method of the Korean Patent Publication No. 2006-0042989 classifies physical volumes in physical disks by performance-dependent groups such as a pass unit, an RAID device unit, and all RAID devices and selects the respective groups in performance order to construct a virtual volume. Herein, the number of disks selected is minimized and disk groups are selected in descending order of a virtual unallocated rate.

This method is suitable for a scheme of managing a storage pool by dividing it into virtual volumes, but is not suitable for a scheme of managing a storage pool by a large-capacity virtual volume according to exemplary embodiments of the following disclosure.

Also, if the conditions of physical disk volumes constituting a storage pool are equal, performance-dependent groups are meaningless. Therefore, it is not efficient to allocate physical disk volumes in descending order of a virtual unallocated rate.

### SUMMARY

In one general aspect of the present invention, a method for selecting a disk volume by a metadata server in an asymmetric cluster file system includes: receiving status information from a data server periodically and adjusting the standby command number of a disk volume in the data server on the basis of the status information; and selecting a disk volume for chunk allocation on the basis of the standby command number in response to a chunk allocation request from a client.

The adjusting the standby command number may include: calculating a variation in the used capacity of the disk volume; and converting the variation to the chunk number and subtracting the chunk number from the standby command number.

The variation in the used capacity of the disk volume may be calculated by comparing the ante-deletion used capacity, which is the sum of the current used capacity of the disk volume calculated from the status information and the capacity of the disk volume deleted by the metadata server after the receipt of the previous status information, to the used capacity of the disk volume stored in the metadata server at the receipt of the previous status information.

The adjusting the standby command number may further include: comparing the variation and a chunk size after the calculating of the variation in the used capacity of the disk volume; detecting the cumulative time during which the used capacity of the disk volume is maintained to be smaller than the chunk size, if the variation is smaller than the chunk size; initializing the cumulative time and the standby command number for the disk volume if the cumulative time is longer than a reference time; and adding the receipt period of the status information to the cumulative time if the cumulative time is not longer than the reference time.

The status information may be stored for each disk volume with respect to all the disk volumes in the data server, and the standby command number may be adjusted sequentially with respect to all the disk volumes in the data server.

The selecting of a disk volume for chunk allocation may include: receiving a chunk allocation request; creating a list of disk volumes with the standby command number smaller than or equal to a predetermined number; selecting a disk volume for chunk allocation from the generated disk volume list; transmitting a chunk allocation request to a data server with the selected disk volume; and receiving a chunk allocation response from the data server and increasing the standby command number for the disk volume.

The selecting of the disk volume for chunk allocation may select the disk volume for chunk allocation among the disk volumes in the disk volume list in a round-robin manner.

The selecting of the disk volume for chunk allocation may select the disk volume with the smallest standby command number as the disk volume for chunk allocation, among the disk volumes in the disk volume list.

If there are disk volumes with a free capacity larger than or equal to a reference capacity, the creating a list of disk volumes may create a list of disk volumes with the standby command number smaller than or equal to the reference number, among the disk volumes with a free capacity larger than or equal to the reference capacity.

The free capacity may be calculated by subtracting the current used capacity and the reserved capacity, which is calculated by converting the standby command number for the disk volume to the chunk size, from the total capacity of the disk volume.

In another general aspect, a method for selecting a disk volume by a metadata server in an asymmetric cluster file system includes: receiving status information from a data server periodically, calculating a variation in the used capacity of a disk volume in the data server, converting the variation to the chunk number, and subtracting the chunk number from the standby command number for the disk volume; and receiving a chunk allocation request from a client, selecting a disk volume for chunk allocation among the disk volumes with the standby command number smaller than or equal to a predetermined number, and increasing the standby command number of the selected disk volume.

The status information may include the standby command number, the free capacity, the cumulative time, the used capacity, and the total capacity of a disk volume in the data server.

In another general aspect, a metadata server of an asymmetric cluster file system includes: a data transceiver unit receiving status information from a data server periodically; a data storage unit storing/managing the received status information; a controller unit adjusting the standby command number for a disk volume on the basis of the status information; and a disk volume selector unit selecting a disk volume for chunk allocation on the basis of the standby command number.

The controller unit may calculate a variation in the used capacity of the disk volume, convert the variation to the number of chunks, and subtract the chunk number from the standby command number for the disk volume; and increase the standby command number of a disk volume for chink allocation, which is selected by the disk volume selector unit.

The controller unit may detect the cumulative time during which the used capacity of the disk volume is maintained to be smaller than the chunk size, if the variation in the used capacity of the disk volume is smaller than the chunk size; and initialize the cumulative time and the standby command number for the disk volume if the cumulative time is longer than a reference time.

The disk volume selector unit may select a disk volume for chunk allocation among the disk volumes with the standby command number smaller than or equal to a reference number.

The disk volume selector unit may select a disk volume for chunk allocation in a round-robin manner, among the disk volumes with the standby command number smaller than or equal to the reference number.

The disk volume selector unit may select the disk volume with the smallest standby command number as the disk volume for chunk allocation, among the disk volumes with the standby command number smaller than or equal to the reference number.

Other features and aspects will be apparent from the following detailed description, the drawings, and the claims.

### BRIEF DESCRIPTION OF THE DRAWINGS

FIG. 1 is a block diagram of an asymmetric cluster file system according to an exemplary embodiment.

FIG. 2 is a diagram illustrating the management of a storage pool in an asymmetric cluster file system.

FIG. 3 is a diagram illustrating the utilization of a total data storage space in an asymmetric cluster file system when a storage pool selects a disk volume in a round-robin manner.

FIG. 4 is a block diagram of a metadata server in an asymmetric cluster file system according to an exemplary embodiment.

FIG. 5 is a flow diagram illustrating an overall process for allocating a chunk in the asymmetric cluster file system according to an exemplary embodiment.

FIG. 6 is a diagram illustrating the structure of data server information and disk volume information stored/managed in the metadata server according to an exemplary embodiment.

FIG. 7 is a flow chart illustrating a process for updating disk volume information in a data storage unit of the metadata server at the status information notification periods according to an exemplary embodiment.

FIG. 8 is a flow chart illustrating a process for disk volume selection and chunk allocation of the metadata server according to an exemplary embodiment.

FIG. 9 is a flow chart illustrating a process for creating a list of disk volumes with a free disk space according to an exemplary embodiment.

### DETAILED DESCRIPTION OF EMBODIMENTS

Hereinafter, exemplary embodiments will be described in detail with reference to the accompanying drawings. Throughout the drawings and the detailed description, unless otherwise described, the same drawing reference numerals will be understood to refer to the same elements, features, and structures. The relative size and depiction of these elements may be exaggerated for clarity, illustration, and convenience. The following detailed description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constrictions may be omitted for increased clarity and conciseness.

The exemplary embodiments of the present invention detect the used capacity and the free capacity of a disk volume in a data server to allocate chunks, thereby making it possible to use a storage space in an asymmetric cluster, file system in a balanced manner.

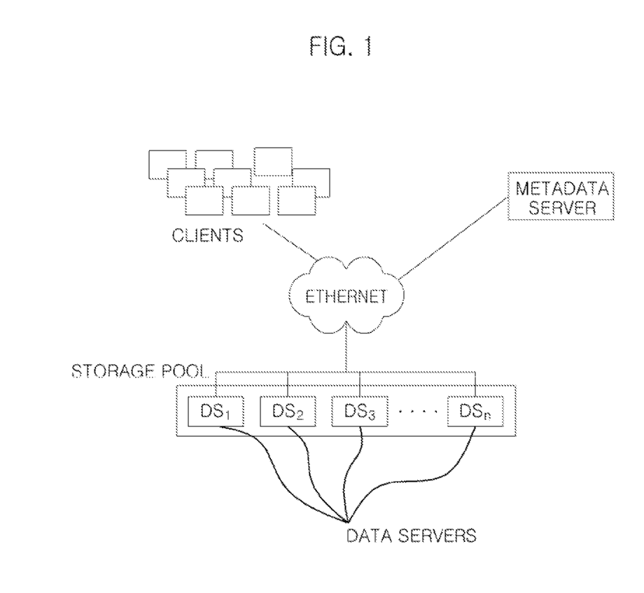

FIG. 1 is a block diagram of an asymmetric cluster file system according to an exemplary embodiment.

Referring to FIG. 1, the asymmetric cluster file system includes a metadata server (MDS), data servers (DSs), and clients, which are connected on a network to interoperate through communication. Herein, the metadata server manages metadata of files, the data servers manage data of the files, and clients access the files.

Through virtualization technology, the data servers are provided as a large-scale single storage space (storage pool) to the clients. Because the failure probability increases as the number of the data servers increases, the asymmetric cluster file system generates replicas of data in consideration of the system availability, and stores the data replicas in the data servers in a distributed manner. Herein, the data are stored in units of a certain size (chunk) in a distributed manner. The above data mirroring and distributed storage technology distributes the I/O load from the clients to the several data servers, thereby improving system performance.

Herein, the metadata server may not detect the status of the data server without accessing the data server because it operates independently of each data server.

Thus, the data server has a function of periodically notifying its own status to the metadata server. That is, the data server periodically transmits its own status information to the metadata server to notify its own configuration, free data capacity, and used data capacity information to the metadata server. The status information is stored and managed in the memory or storage of the metadata server, which is used to operate the data server.

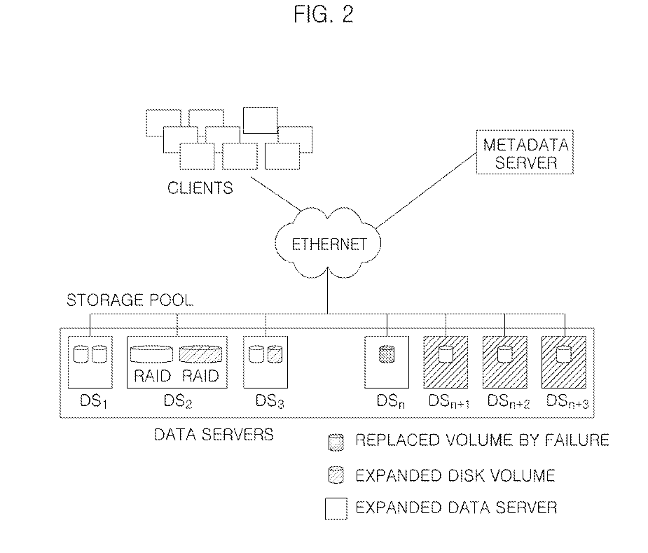

FIG. 2 is a diagram illustrating the management of a storage pool in an asymmetric cluster file system.

Referring to FIG. 2, a new disk volume or an RAID volume may be added in the old data server DS₃ or DS₂, respectively, or new data servers DSₙ₊₁ to DSₙ₊₃ may be added in the storage pool to expand the data storage space. Or, a failed disk volume can be replaced with a new disk volume in the data server DSₙ.

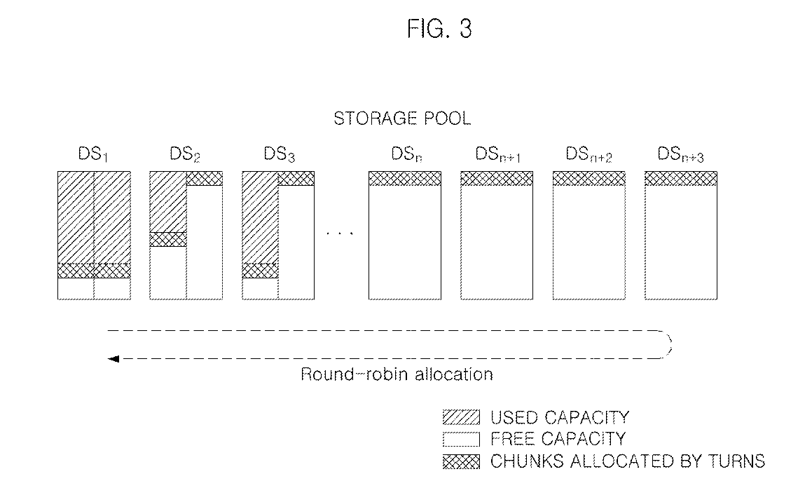

FIG. 3 is a diagram illustrating the utilization of a total data storage space in an asymmetric cluster file system when a storage pool selects a data storage disk volume in a conventional round-robin manner.

Referring to FIG. 3, allocating chunks for a total of (n+3) data servers in a round-robin manner causes an imbalance in data storage space between the old disk volumes DS₁, DS₂ and DS₃, and the new disk volumes of the data servers DSₙ, DSₙ₊₁, DSₙ₊₂ and DSₙ₊₃.

Consequently, if data continue to be stored in a structure with only several data servers, the old disk volumes are filled first, thus reducing the number of free disk volumes. Therefore, new files are stored in the remaining few data servers in a concentrated manner. In the case of an application having concentrated access to new files for a certain period, such concentrated storage may cause the total performance degradation as explained in the description of the related art.

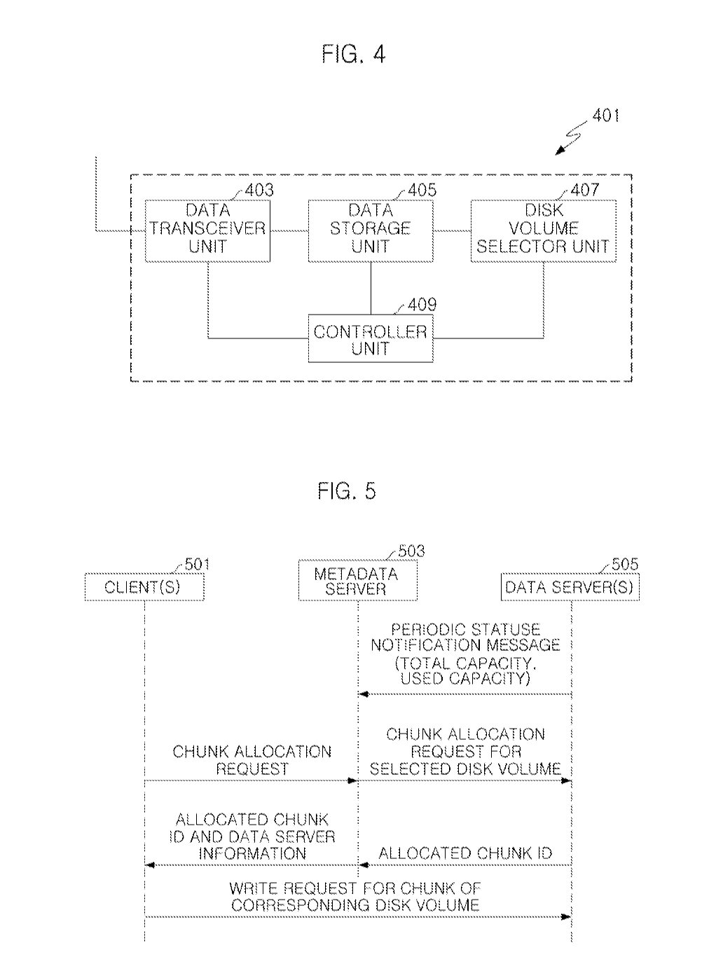

FIG. 4 is a block diagram of a metadata server in an asymmetric cluster file system according to an exemplary embodiment of the present invention.

Referring to FIG. 4, a metadata server 401 includes a data transceiver unit 403, a data storage unit 405, a disk volume selector unit 407, and a controller unit 409. The data transceiver unit 403 communicates with external entities, and in particular, receives status information from data servers (not illustrated) periodically. The data storage unit 405 stores the received status information and metadata. The disk volume selector unit 407 selects a disk volume upon a data storage request of a client (not illustrated). The controller unit 409 controls the data transceiver unit 403, the data storage unit 405, and the disk volume selector unit 407.

FIG. 5 is a flow diagram illustrating an overall process for allocating a chunk to store data in a distributed manner in the asymmetric cluster file system according to an exemplary embodiment. Herein, the chunk is defined as a unit of a certain size to store data in a distributed manner.

Referring to FIG. 5, a data server 505 periodically transmits data storage utilization information, i.e., status information to a metadata server 503. The metadata server 503 stores and manages the status information in its data storage unit in order to select a data storage disk volume.

A client 501 transmits a chunk allocation request for data storage to the metadata server 503. Upon receiving the chunk allocation request from the client 501, the metadata server 503 selects a suitable disk volume according to a disk volume selection method (which will be described later) and transmits a chunk allocation request to the data server 505. Upon receiving an allocated chunk identifier (ID) from the data server 505, the metadata server 503 notifies the client 501 of the allocated chunk ID and the corresponding data server information. Then, the client 501 transmits a data write request for the allocated chunk to the data server 505.

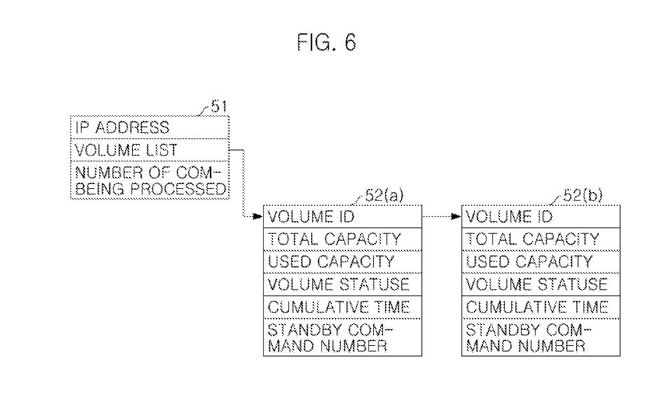

FIG. 6 is a diagram illustrating the structure of data server and disk volume information stored/managed in the metadata server according to an exemplary embodiment.

Referring to FIG. 6, the data server and the disk volume information are generated to register the corresponding data server or disk volume in the metadata server. The data server and the disk volume information are updated at the status information notification periods of the data server. The data server and the disk volume information are deleted from the data storage unit when the corresponding data server or disk volume is explicitly removed from the metadata server.

The data server information stored/managed in the data storage unit includes an IP address of the data server, a list of disk volumes in the data server, and the number of commands being processed by the data server. The disk volume information stored/managed in the data storage unit includes a disk volume identifier (ID), total disk volume capacity, used capacity, current disk volume status, cumulative time, deleted capacity, and the number of standby commands (hereinafter simply referred to as the standby command number).

The disk volume ID is allocated by the metadata server at the initial registration stage. The disk volume ID is used to identify which disk volume is related to the disk volume information transmitted at the status information notification periods, and to determine the disk volume to apply the information.

The cumulative time is a time period dining which a variation in the used capacity of the disk volume is maintained to be smaller than or equal to a chunk size. The cumulative time is checked and cumulated at the status information notification periods, or is set to the current system time. The cumulative time value is used to store other data by releasing the remaining reserved capacity for the chunk in which data are not stored for a predetermined reference time even if the chunk is allocated to the disk volume on the request of the client.

The deleted capacity is a chunk capacity deleted between the status information notification periods. The deleted capacity information is initialized upon receipt of the next status information notification. The deleted capacity information is used to update the disk volume information in the data storage unit at the status information notification periods.

The standby command number is a value indicating the write load on the corresponding disk volume. The standby command number corresponds to the number of standby chunks (hereinafter simply referred to as the standby chunk number) after receipt of a data write request from the client. This information is used to estimate the writing load and the real-time used capacity of the corresponding disk volume in a chunk selection method.

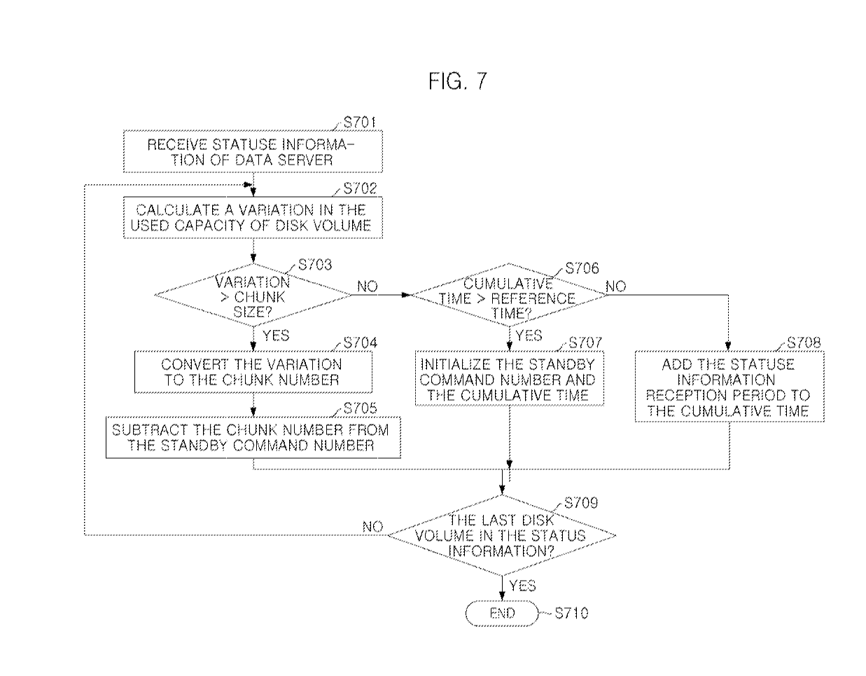

FIG. 7 is a flow chart illustrating a process for updating disk volume information in the data storage unit of the metadata server at the status information notification periods according to an exemplary embodiment.

Referring to FIG. 7, upon receiving status information from the data server in step S701, the metadata server calculates a variation in the used capacity of a disk volume storing data on the basis of the received status information in step S702.

The data server may generate and transmit status information on all of its disk volumes simultaneously. Or, the status information on each disk volume can be generated and transmitted separately.

If the data server transmits status information of its disk volumes simultaneously, it may perform an information update process for all of its disk volumes, which will be described later.

In order to calculate the variation in the used capacity of the disk volume, the metadata server calculates the ante-deletion used capacity by adding the used capacity of the disk volume, calculated from the status information, and the deleted capacity of the disk volume, detected from information about the corresponding disk volume in its data storage unit.

A free capacity increment FREE_CAPA of the disk volume corresponding to the deleted capacity offsets the used capacity USED_CAPA caused by data storage. Thus, if there is no big difference between the current used capacity and the previous used capacity, or if the deleted capacity is greater than the stored capacity, it appears, on the contrary, that the current used capacity is reduced. Therefore, it is difficult to determine how many chunks are completely written.

Thus, the metadata server calculates the variation in the used capacity of the disk volume by comparing the calculated ante-deletion used capacity with the previous used capacity of the corresponding volume information in the data storage unit.

The metadata server compares a chunk size and the calculated variation in the used capacity of the disk volume in step S703.

If the calculated variation in the used capacity of the disk volume is smaller than the chunk size, it means that a write operation was not performed on the chunk. Therefore, the metadata server detects the cumulative time of information about the corresponding disk volume in the data storage unit (i.e., the cumulative time during which the variation in the used capacity of the disk volume is maintained to be smaller than the chunk size) and compares the detected cumulative time with a predetermined reference time in step S706.

If the calculated cumulative time is greater than the reference time, the metadata server initializes the cumulative time and the standby command number of the corresponding disk volume in the data storage unit in step S707. If the client requests a chunk for data storage but data are not actually stored for a long time, it is necessary to release the reserved status of the corresponding chunk for storage space utilization. The reference time may be set or changed according to the system policy or the user's intention for data storage.

If the calculated cumulative time is smaller than the reference time, the metadata server may automatically cumulate the time by the system clock until the arrival of the next status information, or may maintain it until the receipt of the next status information after adding the status information receipt period uniformly to the cumulative time in step S708.

If the calculated variation in the used capacity of the disk volume is greater than the chunk size, the metadata server converts the used capacity variation to the chunk number by dividing it by the chunk size in step S704. Since it means that as many write requests as the chunk number are processed for the corresponding volume, the metadata server subtracts the chunk number from the standby command number of the disk volume information in the data storage unit in step S704.

The metadata server determines if the processed information update is for the last disk volume among the disk volumes written in the status information in step S709. If the processed information update is not for the last disk volume, the metadata server may return to the step S702.

If the processed information update is for the last disk volume, the metadata server ends the updating process in step S710. Even if the data server has transmitted status information for each disk volume, the metadata server ends the updating process because the corresponding update process is for the last disk volume in the status information.

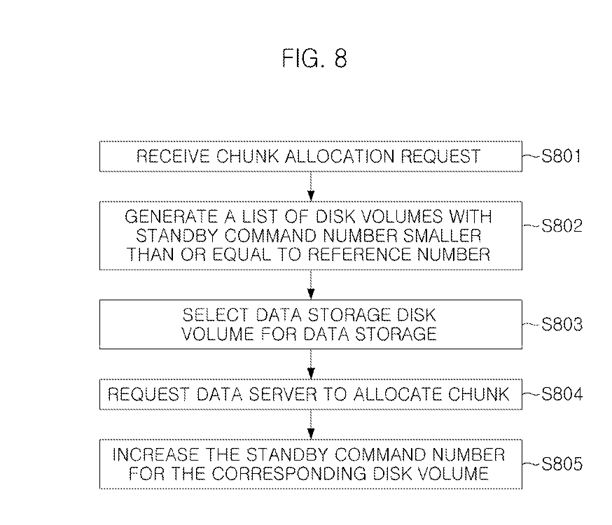

FIG. 8 is a flow chart illustrating a process for disk volume selection and chunk allocation of the metadata server according to an exemplary embodiment.

Referring to FIG. 8, upon receiving a chunk allocation request from the client in step S801, the metadata server creates a list of disk volumes with the standby command number smaller than or equal to a predetermined reference number in step S802. If the standby command number is small, it means that there is a small write load on the corresponding disk volume. Therefore, the metadata server creates the disk volume list on the basis of the standby command number in order to distribute the write load and increase the data storage processing rate. The reference number may be set or changed in consideration of the data storage capacity of the entire system.

The metadata server selects a data storage disk volume from the created disk volume list in step S803. The metadata server may select the data storage disk volume from the disk volume list randomly or in a round-robin manner. Also, the metadata server may select the data storage disk volume with the smallest standby command number in further consideration of the balanced use of the storage space.

Upon selecting the data storage disk volume, the metadata server transmits a chunk allocation request to the data server with the selected data storage disk volume in step S804. If the chunk allocation is successfully performed by the data server and the allocated chunk ID is received therefrom, the metadata server increases the standby command number of the corresponding disk volume in the data storage unit. Herein, the standby command number is increased by a factor of ‘I’ in order to indicate that there are as many write loads. The increment of the standby command number may be set or changed in consideration of the conditions of the entire system. The increased standby command number is adjusted at the status information notification periods when the corresponding disk volume is updated.

If the metadata server receives a chunk deletion request from the client, the metadata server transmits a chunk deletion request to the corresponding data server. Upon receiving a chunk deletion completion notification from the corresponding data server, the metadata server increases information about the deleted capacity of the corresponding disk volume in the data storage unit as much as the number of the deleted chunks in step S805.

Referring to FIG. 8, the metadata server may select the disk volume with the remaining free capacity larger than or equal to a predetermined reference capacity, before creating the list of the disk volumes with the standby command number smaller than or equal to the reference number. The metadata server may select the disk volume with a small write load among the disk volumes with a free storage capacity to perform a data storage operation, thereby making it possible to use the data storage space more efficiently and perform the data storage operation more rapidly.

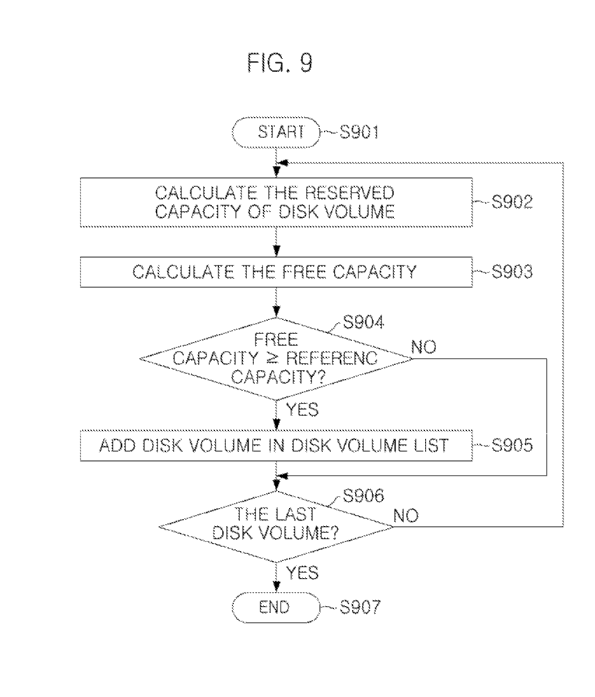

FIG. 9 is a flow chart illustrating a process for creating a list of disk volumes with free disk space according to an exemplary embodiment.

Referring to FIG. 9, upon receiving a chunk allocation request from the client in step S901, the metadata server calculates a reserved capacity for each disk volume in the data storage unit in step S902.

The reserved capacity is calculated by converting the current standby command number in the corresponding disk volume information in the data storage unit to the chunk size.

Thereafter, the metadata server calculates a free capacity of each disk volume in consideration of the reserved capacity in step S903. The reason for this is that the disk volume information is not real-time information but information updated at certain periods. As the status information notification period of the data server increases or as the amount of data stored increases, difference between the actual capacity and the capacity of the disk volume managed by the data storage unit becomes larger.

If the chunk allocation is performed in consideration of only the capacity of the disk volume information in the data storage unit, the number of chunks allocated becomes larger than the number of chunks storable in the disk volume. In this case, the write request from the client is difficult to process stably, thus degrading the write performance. Therefore, the free capacity is calculated in consideration of the reserved capacity.

The metadata server compares the calculated free capacity with a predetermined reference capacity in step S904. If the free capacity is larger than or equal to the reference capacity, the metadata server adds the disk volume in the disk volume list in step S905. The reference capacity may be set to values suitable for stable system operation, depending on the system conditions.

Not only when the disk volume is added in the disk volume list, but also when the disk volume is not added in the disk volume list because the free capacity is less than the reference capacity, the metadata server determines whether the disk volume is the last disk volume in step S906. If the disk volume is not the last disk volume, the process returns to the step S902, and if the disk volume is the last disk volume, the metadata server ends the process in step S907.

Then, the metadata server creates a list of disk volumes with the standby command number smaller than or equal to a predetermined reference number, among a list of disk volumes with the free capacity larger than the reference capacity in step S802, and continues to perform the subsequent operations.

If there is no disk volume with the standby command number smaller than or equal to the reference number, the metadata server may select disk volumes among the disk volumes with the free capacity larger than or equal to the reference capacity, in a random manner, in a round-robin manner, or in the manner of selecting the disk volume with the largest free capacity. If there is no disk volume with the free capacity larger than or equal to the reference capacity, the metadata server may select disk volumes on the basis of only the standby command number.

Also, the metadata server may create a new disk volume list by readjusting the reference capacity and the reference number.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method for selecting a disk volume by a metadata server in an asymmetric cluster file system, comprising:
receiving status information from a data server periodically and adjusting a standby command number of a disk volume in the data server on the basis of the status information; and
selecting a disk volume for chunk allocation on the basis of the standby command number in response to a chunk allocation request from a client.

2. The method of claim 1, wherein the adjusting the standby command number comprises:
calculating a variation in used capacity of the disk volume; and
converting the variation to a chunk number and subtracting the chunk number from the standby command number.

3. The method of claim 2, wherein the variation in the used capacity of the disk volume is calculated by comparing ante-deletion used capacity, which is the sum of the current used capacity of the disk volume calculated from the status information and capacity of the disk volume deleted by the metadata server after the receipt of the previous status information, to the used capacity of the disk volume stored in the metadata server at the receipt of the previous status information.

4. The method of claim 2, wherein the adjusting the standby command number further comprises:
comparing the variation and a chunk size after the calculating of the variation in the used capacity of the disk volume;
detecting a cumulative time during which the used capacity of the disk volume is maintained to be smaller than the chunk size, if the variation is smaller than the chunk size;
initializing the cumulative time and the standby command number for the disk volume if the cumulative time is longer than a reference time; and
adding a receipt period of the status information to the cumulative time if the cumulative time is not longer than the reference time.

5. The method of claim 1, wherein the status information is stored for each disk volume with respect to all the disk volumes in the data server, and the standby command number is adjusted sequentially with respect to all the disk volumes in the data server.

6. The method of claim 1, wherein the selecting of a disk volume for chunk allocation comprises:
receiving a chunk allocation request;
creating a list of disk volumes with the standby command number smaller than or equal to a predetermined number;
selecting a disk volume for chunk allocation from the generated disk volume list;
transmitting a chunk allocation request to a data server with the selected disk volume; and
receiving a chunk allocation response from the data server and increasing the standby command number for the disk volume.

7. The method of claim 6, wherein the selecting of the disk volume for chunk allocation selects the disk volume for chunk allocation among the disk volumes in the disk volume list in a round-robin manner.

8. The method of claim 6, wherein the selecting of the disk volume for chunk allocation selects the disk volume with the smallest standby command number as the disk volume for chink allocation, among the disk volumes in the disk volume list.

9. The method of claim 6, wherein the creating a list of disk volumes creates a list of disk volumes with the standby command number smaller than or equal to the reference number, among the disk volumes with a free capacity larger than or equal to the reference capacity, if any.

10. The method of claim 9, wherein the free capacity is calculated by subtracting the current used capacity and the reserved capacity, which is calculated by converting the standby command number for the disk volume to the chunk size, from the total capacity of the disk volume.

11. A method for selecting a disk volume by a metadata server in an asymmetric cluster file system, comprising:
receiving status information from a data server periodically, calculating a variation in used capacity of a disk volume in the data server, converting the variation to the chunk number, and subtracting the chunk number from a standby command number for the disk volume; and
receiving a chunk allocation request from a client, selecting a disk volume for chunk allocation among the disk volumes with the standby command number smaller than or equal to a predetermined number, and increasing the standby command number of the selected disk volume.

12. The method of claim 11, wherein the status information includes the standby command number, free capacity, cumulative time, used capacity, and total capacity of a disk volume in the data server.

13. A metadata server of an asymmetric cluster file system, comprising:
a data transceiver unit receiving status information from a data server periodically;
a data storage unit storing/managing the received status information;
a controller unit adjusting a standby command number for a disk volume on the basis of the status information; and
a disk volume selector unit selecting a disk volume for chunk allocation on the basis of the standby command number.

14. The metadata server of claim 13, wherein the controller unit:
calculates a variation in the used capacity of the disk volume, converts the variation to the number of chunks, and subtracts the chunk number from the standby command number for the disk volume; and
increases the standby command number of a disk volume for chunk allocation, which is selected by the disk volume selector unit.

15. The metadata server of claim 14, wherein the controller unit:
detects the cumulative time during which the used capacity of the disk volume is maintained to be smaller than the chunk size, if the variation in the used capacity of the disk volume is smaller than the chunk size; and
initializes the cumulative time and the standby command number for the disk volume if the cumulative time is longer than a reference time.

16. The metadata server of claim 13, wherein the disk volume selector unit selects a disk volume for chunk allocation among the disk volumes with the standby command number smaller than or equal to a reference number.

17. The metadata server of claim 16, wherein the disk volume selector unit selects a disk volume for chunk allocation in a round-robin manner, among the disk volumes with the standby command number smaller than or equal to the reference number.

18. The metadata server of claim 16, wherein the disk volume selector unit selects the disk volume with the smallest standby command number as the disk volume for chunk allocation, among the disk volumes with the standby command number smaller than or equal to the reference number.
